(19) United States
(12) Patent Application Publication
(10) Pub. No.: US 2008/0158671 A1
(43) Pub. Date: Jul. 3, 2008

(54) Three-Dimensional Image Display Apparatus Using Flat Panel Display

(75) Inventor: Byoung Su Lee, Jeollanam-do (KR)

Correspondence Address: CANTOR COLBURN, LLP, 20 Church Street, 22nd Floor, Hartford, CT, 06103, US

(73) Assignee: Siliconfile Technologies Inc., Seoul (KR)

(21) Appl. No.: 11/912,330

(22) PCT Filed: May 8, 2006
(86) PCT No.: PCT/KR06/01717

§ 371 Date: Oct. 23, 2007

(30) Foreign Application Priority Data
May 9, 2005 (KR) 10-2005-0038266

(51) Int. Cl. G02B 27/22

(52) U.S. Cl. 359/462

(57) ABSTRACT

A three-dimensional image display apparatus using a flat panel display unit is provided. The three-dimensional image display apparatus includes a flat panel display unit, reflecting plate arrays reflecting incident light, and a vibrator vibrating the reflecting plate arrays from left to right or from right to left, wherein the reflecting plate arrays are moved according to time by an vibration of the vibrator, and wherein a three-dimensional image is displayed by changing an image of the flat panel display unit based on an angle of the reflecting plate arrays. The three-dimensional image display apparatus has advantages that no auxiliary apparatuses such as special glasses are required to recognize the three-dimensional image, and that has no deterioration of an image quality, which is the biggest drawback of a general three-dimensional image display apparatus, and that observation of a three-dimensional image is not limited to one person. Also, the three-dimensional image display apparatus is capable of representing a multi-viewpoint image and selective representation of two-dimensional and three-dimensional images.

### TECHNICAL FIELD

The present invention relates to a three-dimensional image display apparatus, more particularly, to a three-dimensional image display apparatus using a flat panel display unit capable of displaying a binocular-viewpoint and multi-viewpoint three-dimensional images by confining and controlling an angle of light emission of the image display apparatus.

### BACKGROUND ART

Generally, techniques for displaying a three-dimensional image are divided into two categories. One is a method using binocular parallax, which is also called a stereoscopic technique, and the other is a method using a multi-viewpoint technique. In the method using the binocular parallax, three-dimensional feeling of an image is obtained from different images of a three-dimensional object which are recognized by both eyes of an observer. A method using a lenticular lens, a method using a parallax barrier, a method using a polarizing film, or a method using an electronic shutter is proposed as the method using the binocular parallax.

In the method using the multi-viewpoint technique, multiple images for a plurality of directions of the three-dimensional object can be observed. Since the image moves as an observer moves, it is possible for a plurality of observers to observe the three-dimensional image. Examples of the method using the multi-viewpoint technique are a method using a lenticular lens, a method using a hologram, and the like.

Generally, for a three-dimensional image display apparatus using a flat panel display, a method using a lenticular lens, a parallax barrier, or a polarizing film is used.

And in the method, a representation of a pixel of a horizontal axis of a flat panel display unit is divided into a left-side image and a right-side image, so that different images are observed by both eyes of an observer, respectively, to produce a three-dimensional image.

FIG. 1 is a diagram illustrating a conventional three-dimensional image display apparatus using a lenticular lens.

Referring to FIG. 1, the lenticular lens 105 is installed on the flat panel display unit 101, so that light of pixels of the flat panel display unit are alternatively directed to a left focus or a right focus according to a located sequence. In the method using the parallax barrier, which is similar to the method using the lenticular lens, the parallax barrier is installed on the flat panel display unit 101 for blocking right-side image signals toward a left eye of an observer to obtain a three-dimensional image.

FIG. 2 is a diagram illustrating a conventional three-dimensional image display apparatus using a polarizing film.

In the conventional method using the polarizing film, first polarizing films 205 and 210 having perpendicular polarization directions with each other are arranged sequentially, and images are observed by an observer through second polarizing films 225 and 230 placed on the eyes of an observer which have same polarization directions as the first polarizing films 205 and 210, respectively to divide left-side and right-side images.

In these methods, one screen of the flat panel display unit is divided into two images for left and right eyes of an observer, respectively, and thus image quality and brightness are decreased to half the quality and brightness of an ordinary two-dimensional image. As a result, a three-dimensional image display apparatus using these methods should have a flat panel display unit with high brightness and high density. To solve this problem, the method using an electronic shutter has been proposed.

FIG. 3 is a diagram illustrating a conventional three-dimensional image display apparatus using an electronic shutter.

A flat panel display unit 301 displays a right-side image and a left-side image one after the other, and an observer wears glasses 310 on which a shutter is installed, and the glasses 310 having the shutter are synchronized with the flat panel display unit 301 to block a left eye or an right eye one after the other.

As a result, at first, a right-side image signal goes through an open right-side lens 305, and next, a left-side image signal goes through an open left-side lens 310 to form a three-dimensional image. In the display apparatus using this shutter method, glasses on which a comparatively complicated apparatus is installed should be worn by an observer.

Generally, a more complicated apparatus should be used for implementing a three-dimensional image display apparatus using the multi-viewpoint technique. The best simple method is a method using a lenticular lens. In this method, different images can be viewed according to a direction of an observer by arranging images viewable from different directions sequentially under the lenticular lens.

In this method, deterioration of an image quality is quite much due to a division of an image of a pixel into sub-images for different directions, thus a very delicate image having over thousands of line per inch (LPI) is required to represent a vivid image. Accordingly, it is impossible to apply this method to a CRT, a LCD, or the like, and thus the method only can be applied to a printing medium such as a picture.

### DISCLOSURE OF INVENTION

### Technical Problem

In order to solve the aforementioned problems, an object of the present invention is to provide a three-dimensional image display apparatus using a general flat panel display unit such as CRT or LCD capable of preventing deterioration of quality and brightness of an image, selectively displaying a two-dimensional or three-dimensional image, and displaying stereoscopic and multi-viewpoint three-dimensional images without a special device such as special glasses.

### Technical Solution

According to an aspect of the present invention, there is provided a three-dimensional image display apparatus using a flat panel display unit comprising: a flat panel display unit; reflecting plate arrays disposed vertically on pixels of the flat panel display unit and arranged horizontally with each other; and a vibrator capable of controlling an angle of the reflecting plate arrays; wherein the angle of reflecting plate arrays are moved according to time by an vibration of the vibrator, and wherein a three dimensional image is displayed by changing an image of the flat panel display unit based on an angle of the reflecting plate arrays. In addition, optic fiber arrays and light-absorbing plates arrays may be used instead of the reflecting plate arrays.

According to another aspect of the present invention, there is provided a three-dimensional image display apparatus using a flat panel display unit comprising: an image obtaining unit obtaining images at multiple viewing angles of an observer; a flat panel display unit displaying an image transferred from the image obtaining unit;

reflecting plate arrays disposed vertically on a line of pixels of the flat panel display unit and arranged horizontally with each other corresponding to the pixels; and a vibrator, which is disposed in one end of the reflecting plate array, vibrating the reflecting plate arrays from right to left or from left to right, wherein a radiation angle of the flat panel display unit is changed by a vibration of the vibrator, and wherein an image obtained at a moment when the radiation angle matches with an angle of an observer is displayed on the flat panel display unit, so that a same image as an image of a three-dimensional object observed at a predetermined degree is displayed on the flat panel display unit.

### BRIEF DESCRIPTION OF THE DRAWINGS

FIG. 1 is a diagram illustrating a conventional three-dimensional image display apparatus using a lenticular lens;

FIG. 2 is a diagram illustrating a conventional three-dimensional image display apparatus using a polarizing film;

FIG. 3 is a diagram illustrating a conventional three-dimensional image display apparatus using an electronic shutter;

FIG. 4 is diagram of a three-dimensional image display apparatus with a flat panel display unit using binocular parallax according to an embodiment of the present invention; and

FIG. 5 is diagram of a three-dimensional image display apparatus with a flat panel display unit using a multi-viewpoint technique according to an embodiment of the present invention.

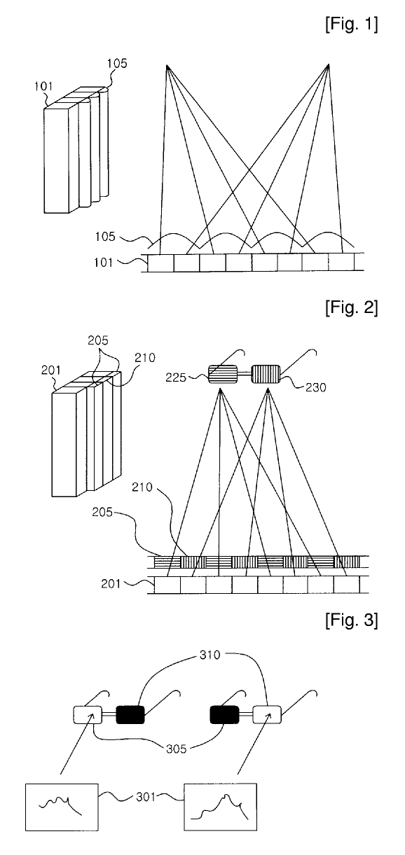

### BEST MODE FOR CARRYING OUT THE INVENTION

Hereinafter, the present will be described in detail with reference to accompanying drawings.

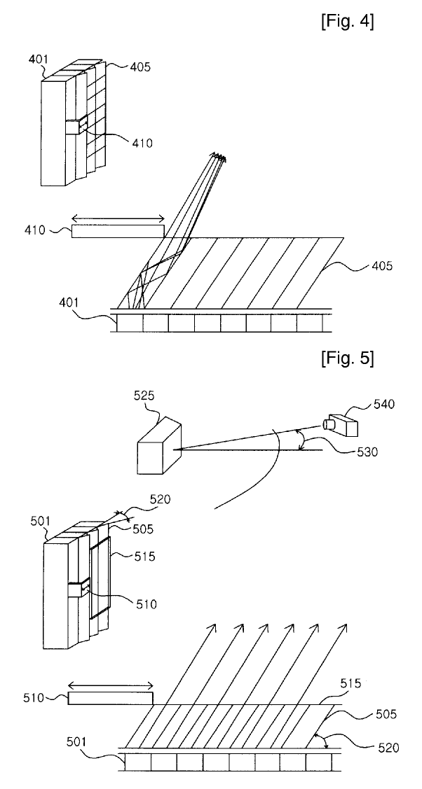

FIG. 4 is diagram of a three-dimensional image display apparatus with a flat panel display unit using binocular parallax according to an embodiment of the present invention.

The three-dimensional image display apparatus includes a flat panel display unit 401, reflection plate arrays 405, and a vibrator 410. The flat panel display unit 401 is a group of unit pixels constituting a LCD or a PDP. The reflecting plate arrays 405 reflect incident light, and the vibrator changes an angle of the reflecting plate arrays by a vibration.

Operations of the three-dimensional image display apparatus using the flat panel display unit according to the embodiment of the present invention will now be described with reference to components illustrated in FIG. 4.

The flat panel display unit 401 and the reflecting plate arrays 405 disposed vertically on pixels of the flat panel display unit 401 are arranged horizontally, respectively. The vibrator 410 controlling an angle of the reflecting plate arrays by a vibration is located in one end of the reflecting plate arrays 405. The angle of the reflecting plate array is changed by a vibration according to time, and light emitted from each pixel is reflected by the reflecting plate arrays 405 to progress straight in a same direction as the angle of the reflecting plate arrays 405.

The apparatus can be used as a three-dimensional image display apparatus using a binocular-viewpoint by changing images of the flat panel display unit 401 according to an angle of the reflecting plate arrays 405. In other words, when the reflecting plate or a blocking plate is directed to the left, the flat panel display unit 401 displays a left-side image, and when the reflecting plate or a blocking plate is directed to the right, the flat panel display unit 401 displays a right-side image, accordingly an observer can recognize a three-dimensional image having binocular parallax.

In addition, when the same images are displayed regardless of the angle of the reflecting plate arrays 405, the observer can observe a two-dimensional flat image, and accordingly it is possible to change into one between two-dimensional and three-dimensional image display apparatuses without requiring an additional apparatus.

The reflecting plate arrays 405 may be replaced with an optic fiber array or a non-transparent light-absorbing plate. When the reflecting plate array 405 is replaced with the optic fiber array, light is directed straightly in a direction of the optic fiber, and the optic fiber array function the same as the reflecting plate arrays 405. When the reflecting plate arrays 405 are replaced with the light-absorbing plate, most of the light is absorbed, and only the light in a predetermined direction is eradicated to reduce brightness of an image. The three-dimensional image display apparatus using the flat panel display unit prevents light which has been eradicated from a pixel from eradicating to an area which is not located in a predetermined direction using various methods.

FIG. 5 is diagram of a three-dimensional image display apparatus with a flat panel display unit using a multi-viewpoint technique according to an embodiment of the present invention.

The flat panel display unit 501 and the reflecting plate arrays 505 disposed vertically on pixels of the flat panel display unit 501 are arranged horizontally, respectively. The vibrator 510 adjusting an angle of the reflecting plate array by a vibration is located in one end of the reflecting plate arrays 505. The angle of the reflecting plate array is changed by a vibration according to time, and light emitted from each pixel is reflected by the reflecting plate arrays 505 to progress straight in a same direction as the angle of the reflecting plate array.

In addition, the reflecting plate arrays 505 is supported by a supporting member 515, and the supporting member 515 enables the whole reflecting plate arrays 505 to be moved maintaining a same degree.

An object 525 has different two-dimensional images based on an angle 530 of an observer. Thus, an image obtaining unit is used to obtain an image according to the angle (530) of the observer, and the image obtaining unit may be a camera 540 or an image processing tool of a computer.

When several images, which have been obtained by the image obtaining unit, are represented by the three-dimensional image display apparatus using the flat panel display unit according to the embodiment of the present invention, a radiation angle 520 of each pixel is changed by vibration of a vibrator 510, and an image at a moment when the angle of the observer matches with the angle of the radiation while the angle of radiation is varied, is displayed on the flat panel display unit 501 to enable the observer to observe a same image as an image of a three-dimensional object 525 viewed from a predetermined angle. Accordingly, the observer can recognize a three-dimensional object regardless of an angle of the observer.

While the present invention has been particularly shown and described with reference to exemplary embodiments thereof, it will be understood by those skilled in the art that various changes in form and details may be made therein without departing from the spirit and scope of the invention as defined by the appended claims.

### INDUSTRIAL APPLICABILITY

Accordingly, the present invention has an advantage of preventing deterioration of an image quality, since it is not required to divide one screen of the flat panel display unit into two images for left-side and right-side images as is required when a lenticular lens or a polarizing film is used.

The present invention has an advantage that an observer can recognize light stronger than a light of general two-dimensional display device, since all of the radiated light is directed to the observer to incur no decrease of light when the reflecting plate arrays 405 and 505 are used.

When the reflecting plate arrays 405 or 505 are replaced with an optic fiber arrays the same effect can be obtained since the optical fiber arrays have the same property as the reflecting plate arrays 405 and 505. When the reflecting plate array is replaced with a light-absorbing plate, most of the light is absorbed, and only the light in a predetermined direction is radiated, so that the observer observes an image darker than in a case of using the reflecting plate arrays.

1. A three-dimensional image display apparatus using a flat panel display unit comprising:
a flat panel display unit;
reflecting plate arrays disposed vertically on a line of pixels of the flat panel display unit and arranged horizontally with each other corresponding to the pixels; and
a vibrator, which is disposed in one end of the reflecting plate arrays, vibrating the reflecting plate arrays from left to right or from right to left,
wherein the reflecting plate arrays are moved according to time by an vibration of the vibrator, and
wherein a three dimensional image is displayed by changing an image of the flat panel display unit based on an angle of the reflecting plate arrays.

2. The three-dimensional image display apparatus of claim 1, wherein the flat panel display unit displays a left-side image when the reflecting plate arrays are moved to the left and displays a right-side image when the reflecting plate arrays are moved to the right.

3. The three-dimensional image display apparatus of claim 1, wherein the three-dimensional image display apparatus is converted into a two-dimensional image display apparatus, when a same image is displayed on the flat panel display unit regardless of a movement of the reflecting plate arrays.

4. The three-dimensional image display apparatus of claim 1, wherein the reflecting plate arrays are replaced with optic fiber arrays.

5. The three-dimensional image display apparatus of claim 1, wherein the reflecting plate arrays are replaced with light-absorbing plate arrays.

6. A three-dimensional image display apparatus using a flat panel display unit comprising:
an image obtaining unit obtaining images at multiple viewing angles of an observer;
a flat panel display unit displaying an image transferred from the image obtaining unit;
reflecting plate arrays disposed vertically on a line of pixels of the flat panel display unit and arranged horizontally with each other corresponding to the pixels; and
a vibrator, which is disposed in one end of the reflecting plate array, vibrating the reflecting plate arrays from right to left or from left to right,
wherein a radiation angle of the flat panel display unit is changed by a vibration of the vibrator, and
wherein an image obtained at a moment when the radiation angle matches with an angle of an observer while the angle of radiation is varied is displayed on the flat panel display unit, so that a same image as an image of a three-dimensional object observed at a predetermined angle is displayed on the flat panel display unit.

7. The three-dimensional image display apparatus of claim 6, wherein the image obtaining unit is a camera or an image processing tool of a computer.

8. The three-dimensional image display apparatus of claim 6, wherein the reflecting plate arrays are supported by a supporting member, so that an angle of the whole the reflecting plate arrays changes to a same value.

9. The three-dimensional image display apparatus of claim 6, wherein the reflecting plate arrays are replaced with optic fiber arrays.

10. The three-dimensional image display apparatus of claim 6, wherein the reflecting plate arrays are replaced with light-absorbing plate arrays.
